(19) United States
(12) Patent Application Publication
(10) Pub. No.: US 2016/0008752 A1
(43) Pub. Date: Jan. 14, 2016

(54) VERTICAL GAS/LIQUID PHASE SEPARATOR

(71) Applicant: Robert McKENZIE, Chestermere (CA)

(72) Inventor: Robert McKENZIE, Chestermere (CA)

(21) Appl. No.: 14/339,513

(22) Filed: Jul. 24, 2014

Related U.S. Application Data
(60) Provisional application No. 62/023,357, filed on Jul. 11, 2014.

(51) Int. Cl. B01D 45/16

(52) U.S. Cl. CPC B01D 45/16

(57) ABSTRACT

There is provided a separator for a gas stream. The separator has a vertical tank having a side wail, a top and a bottom. The tank has an inlet, a gas outlet, and a liquid outlet, the liquid outlet being located at the bottom of the tank. There is a helically arranged baffle within the vertical tank, the baffle being arranged to define a flow path between the inlet and the gas outlet, the flow path being helical about a central axis of the vertical tank, the baffle having an upper surface that is angled downward from the central axis toward the side wall of the vertical tank, and the baffle terminating in a trough potion at a lower edge

### TECHNICAL FIELD

This relates to a separator tank for separating a multiphase fluid flow, such as may be used to separate liquid and gases in a stream of production fluids from a hydrocarbon well.

### BACKGROUND

In order to process production fluids from a hydrocarbon well, it is often necessary to separate the various phases, such as liquid and gases. The separation strategies will depend on the type of well and the composition of the production fluids. However, generally speaking there will be sand, water liquid hydrocarbons, and gas hydrocarbons. Small amounts of other components may be present as well but are not considered here.

In fluid streams that are primarily gas, strategies are often used to knock out the liquid from the gas stream. Examples of separators that may be used for this purpose can he found in United States pregrant publication no. 20130255206 (McKenzie) entitled “Separator for a Gas Stream” and United States pregrant publication no. 20130255205 (McKenzie) “Separator for a Gas Stream Using a Vortex”.

### SUMMARY

According to an aspect, there is provided a separator for a gas stream, comprising a vertical tank having a side wall, a top and a bottom. The tank has an inlet, a gas outlet, and a liquid outlet, the liquid outlet being located at the bottom of the tank. There is a helically arranged baffle within the vertical tank, the baffle being arranged to define a flow path between the inlet and the gas outlet, the flow path being helical about a central axis of the vertical tank, the baffle having an upper surface that is angled downward from the central axis toward the side wall of the vertical tank, the baffle terminating in a trough potion at a lower edge.

According to another aspect, the upper surface of the baffle may be at an angle of 25 to 35 degrees.

According to an aspect, there is provided a method of separating liquid from gas in a fluid flow, the method comprising the steps of providing a vertical tank having a side wall, a top, a bottom, an inlet, a gas outlet, and a liquid outlet, the liquid outlet being located at the bottom of the tank, placing a helically arranged baffle within the vertical tank, the baffle having an upper surface that is angled downward from the central axis toward the side wall of the vertical tank, the baffle terminating in a trough portion at a lower edge, introducing a fluid comprising gas and liquid to the tank through the inlet, flowing the fluid on a helical flow path about a central axis of the vertical tank using the baffle, separating the fluid into the gas and the liquid, the liquid travelling down the upper surface of the baffle into the trough portion, and collecting the gas from the gas outlet and the liquid from the liquid outlet.

According to another aspect, the upper surface of the baffle may be at an angle of 25 to 35 degrees.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of the separation tank with a helical baffle.

FIG. 2 is a detailed side elevation view of a trough portion of the helical baffle.

FIG. 3 is a detailed side elevation view of an alternative trough portion of the helical baffle.

### DETAILED DESCRIPTION

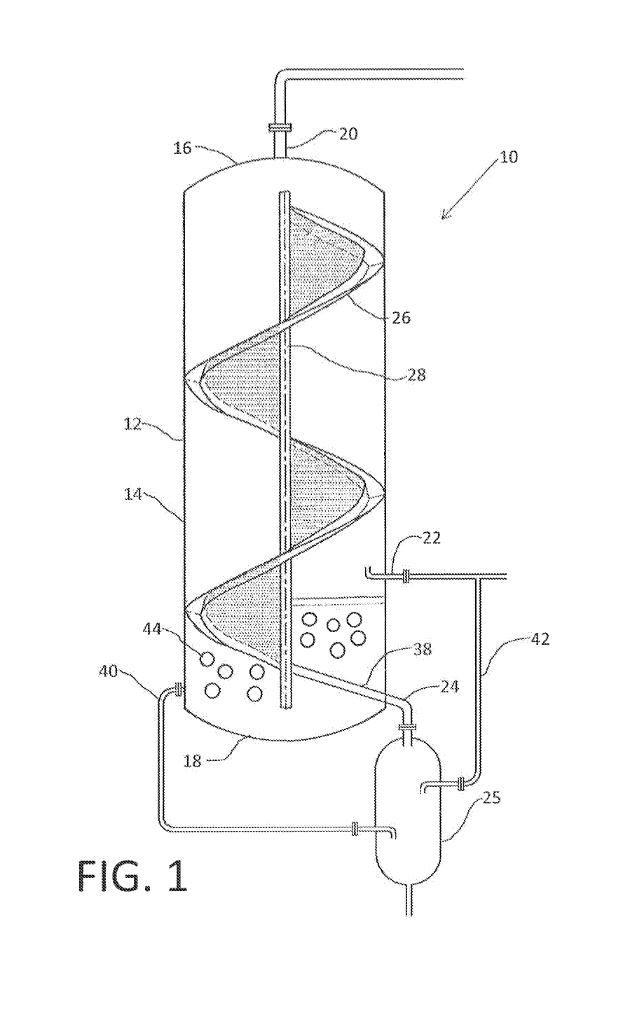

A separator for a gas stream generally identified by reference numeral 10, will now be described with reference to FIG. 1 through 3.

Referring to FIG. 1, separator it) has a vertical tank 12 having a side wall 14, a top 16, and a bottom 18. Tank 12 as shown has a curved top 16 and bottom 18 as is common in the art, however it will be understood that tank 12 may be any vertical tank shape known in the art. Side wall 14 is preferably a continuous cylinder. Tank 12 has an inlet 20, a gas outlet 22, and a liquid outlet 24. Liquid outlet 24 is located at the bottom of tank 12 in order to collect separated liquid from tank 12 and has a collection tank 25 with a dump valve that allows liquids to be selectively removed in order to maintain pressure within tank 12.

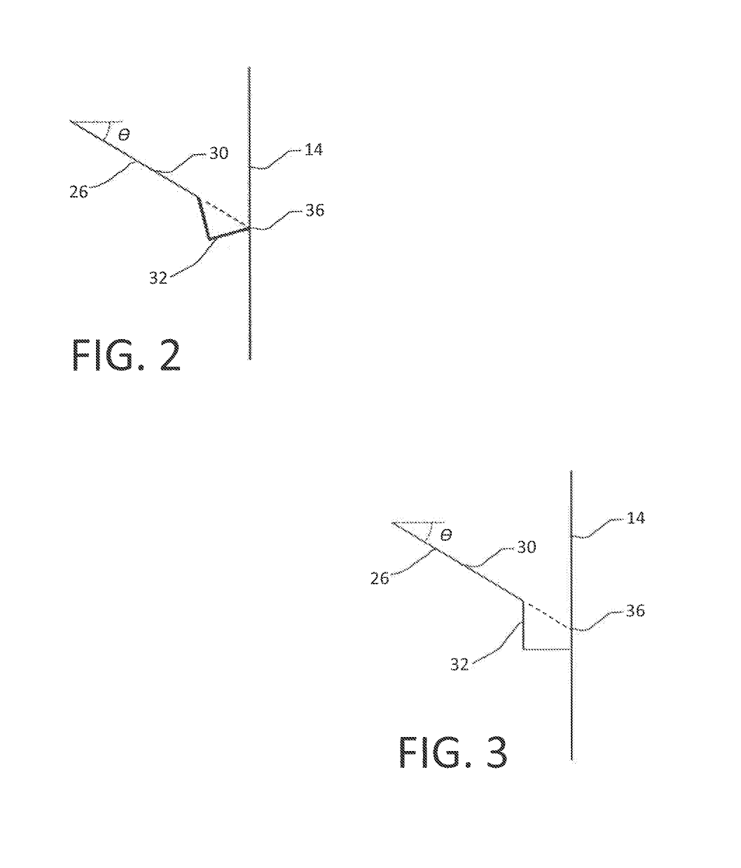

Within tank 12 is a helically arranged baffle 26. Preferably, baffle 26 is a flat surface. Baffle 26 obstructs the flow of the fluid, and is arranged to define a flow path between inlet 20 and gas outlet 22 that is helical about a central axis 28 of vertical tank 12. Baffle 26 has an upper surface 30 that is angled downward from central axis 28 toward side wall 14. As can be seen in FIGS. 2 and 3, upper surface 30 of baffle 26 angles down from central axis 28 toward side wall 14 at an angle (θ) of about 30 degrees. This angle may vary to optimize the flow, but is preferably between about 25 to about 35 degrees.

Baffle 26 terminates in a trough portion 32 at a lower edge 34. Using trough portion 32, liquid that is collected flows down along baffle 26 and side wall 14 toward liquid outlet 24. As shown in FIG. 2, trough portion 32 is preferably V-shaped, however, trough portion 32 could have any shape useful for collecting fluid and directing its flow, such as a square trough shown in FIG. 3, or other shapes as will be understood by one skilled in the art. It has been found that the V-shaped channel has some benefits in directing the collected fluids and in connecting to a drain line 38 that may be used as liquid outlet 24. While it is also possible to have a drain at the bottom of tank 12, such as is shown schematically in FIG. 1, it may be preferable to use a drain line that trough portion 32 feeds into directly. This reduces the amount of standing liquid at the bottom of tank 12 that may he picked up again by the gas moving through the tank toward gas outlet 22, which reduces the effectiveness of separator 10. There may also be a second liquid outlet 40 at the bottom of tank 12 in addition to trough portion 32 that tallows any liquids that were not collected by trough portion 32 to also be removed. Preferably, trough portion 32 is designed to connected easily to the drain line. It will be understood that trough portion 32 may change size and shape as it progresses though tank 12. For example, as trough portion 32 approaches the drain line of liquid outlet 24, it may change to a more convenient shape, or it may increase in size as more liquid will have accumulated. In the depicted embodiment, collection tank 25 receives fluid from drain line 38, second liquid outlet 40 and any liquids that may accumulate in gas outlet 22.

It will be understood that, as baffle 26 is angled, there is a natural trough that is formed between sidewall 14 and baffle 26. While a more defined and deeper trough portion 32 helps collect and redirect more liquid, it will be understood that a similar, while less pronounced benefit may be achieved by the natural trough portion that would be formed between baffle 26 and side wall 14. Preferably, as shown in FIGS. 2 and 3, the far side of any trough 32 should be below the point 36 where baffle 26 would normally intersect side wall 14, as represented by the broken line. It may be possible to define a tough portion 32 that is not below this point, however it will be understood that the effectiveness of the trough will be reduced.

In addition to baffle 26, there may be a section at the bottom of tank 12 that is filled with particulate 44. This may help to remove any further liquid in the gas stream.

### Operation

Separator 10 can be used to separate liquid from gas in a fluid flow. When a fluid that has both gas and entrained liquid is introduced into tank 12 through inlet 20, the fluid flows along the helical flow path defined by baffle 26. As baffle 26 is angled downward, the fluid experiences two forces. Centrifugal forces act on the fluid as it flows around baffle 26 and the heavier liquid particles are forced away from the gas particles, separating the flow. As well, the pressure of the fluid drives the fluid flow down the tank, and the liquid flows into trough portion 32. This allows the liquid to be collected at the bottom of tank 12 and removed from tank 12 through liquid outlet 24. The gas can also be collected after separation through gas outlet 22.

in this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A separator for a gas stream, comprising:
a vertical tank having a side wall, a top and a bottom;
the tank having an inlet, a gas outlet, and a liquid outlet, the liquid outlet being located at the bottom of the tank;
a helically arranged baffle within the vertical tank, the baffle being arranged to define a flow path between the inlet and the gas outlet, the flow path being helical about a central axis of the vertical tank,
the baffle having an upper surface that is angled downward from the central axis toward the side wail of the vertical tank; and
the baffle terminating in a trough potion at a lower edge.

2. The separator of claim 1, wherein the upper surface of the baffle is at an angle of 25 to 35 degrees.

3. The separator of claim 1, wherein the trough portion comprises a groove that extends below the upper surface of the baffle.

4. The separator of claim 3, wherein the trough portion is a V-shaped groove.

5. The separator of claim 1, wherein the liquid outlet comprises a drain line connected directly to the trough portion.

6. A method of separating liquid from gas in a fluid flow, the method comprising the steps of:
providing a vertical tank having a side wall, a top, a bottom, an inlet, a gas outlet, and a liquid outlet, the liquid outlet being located at the bottom of the tank;
placing a helically arranged baffle within the vertical tank, the baffle having an upper surface that is angled downward from the central axis toward the side wall of the vertical tank, the baffle terminating in a trough portion at a lower edge;
introducing a fluid comprising gas and liquid to the tank through the inlet;
flowing the fluid on a helical flow path about a central axis of the vertical tank using the baffle;
separating the fluid into the gas and the liquid, the liquid travelling down the upper surface of the baffle into the trough portion; and
collecting the gas from the gas outlet and the liquid from the liquid outlet.

7. The method of claim 6, wherein the upper surface of the baffle is at an angle of 25 to 35 degrees.

8. The method of claim 6, wherein the trough portion comprises a groove that extends below the upper surface of the baffle.

9. The method of claim 8, wherein the trough portion is a V-shaped groove.

10. The separator of claim 9, wherein the liquid outlet comprises a drain line connected directly to the trough portion.
